(19) United States
(12) Patent Application Publication
(10) Pub. No.: US 2011/0179311 A1
(43) Pub. Date: Jul. 21, 2011

(54) INJECTING ERROR AND/OR MIGRATING MEMORY IN A COMPUTING SYSTEM

(76) Inventors: Murugasamy K. Nachimuthu, Beaverton, OR (US); Mohan J. Kumar, Aloha, OR (US); Sarathy Jayakumar, Portland, OR (US); Chung-Chi Wang, Sunnyvale, CA (US)

(21) Appl. No.: 12/971,868

(22) Filed: Dec. 17, 2010

Related U.S. Application Data
(63) Continuation-in-part of application No. 12/655,586, filed on Dec. 31, 2009.

(51) Int. Cl. G06F 11/00

(52) U.S. Cl. 714/42; 714/E11.144

(57) ABSTRACT

In some embodiments a request is received to perform an error injection or a memory migration, a mode is entered that blocks requests from agents other than a current processor core or thread, the error is injected or the memory is migrated, and the mode that blocks requests from the agents other than the current processor core or thread is exited. Other embodiments are described and claimed.

### RELATED APPLICATION

This application is a continuation-in-part application of U.S. patent application Ser. No. 12/655,586 filed on Dec. 31, 2009 and entitled “DYNAMIC SYSTEM RECONFIGURATION” to Murugasamy K. Nachimuthu, Mohan J. Kumar, and Chung-Chi Wang.

### TECHNICAL FIELD

The inventions generally relate to injecting error and/or migrating memory in a computing system.

### BACKGROUND

With the introduction of scalable Quick Path Interconnect (QPI) servers having the capability of building large multiprocessor (MP) systems (for example, with 128 sockets), the reconfiguration of systems becomes very complex. Memory controllers are being integrated into each processor socket. Additionally, other components (such as IO root complex, IO devices . . . ) could be integrated into one or more processor sockets in the future. This adds further complexity in the address routing. Reliability, Availability, and Serviceability (RAS) features such as, for example, processor hot plug and Input/Output Hub (IOH) hot plug, memory migration, CPU Migration . . . are added to the feature list. With this additional complexity and new features, implementing a dynamic system reconfiguration solution in the hardware is very complex and expensive to develop and validate.

RAS operations (especially the one that impact system configuration at runtime) are currently implemented using System Management Interrupt (SMI), where the SMI brings all the processors together, performs a quiesce of QPI agents (such as processors, IOHs, etc.), and reprograms the system configuration (such as QPI routes, address decoders, etc). However, despite the link nature of the QPI interconnect, the changes to all QPI agents (processors, IO Hub . . . ) have to be done atomically to prevent misrouted data traffic. This poses a special challenge when this reconfiguration is performed by SMI code which itself executes out of coherent memory, which cannot be tolerated during QPI route changes. Note further that SMI operation is transparent to the OS (Operating System) and hence it is required to keep SMI latency to a minimum (typically in the order of hundreds of microseconds) for reliable system operation.

It is important for the Operating System (OS) and/or a Virtual Machine Monitor (VMM) to ensure that error recovery and RAS features work. Existing error injection mechanisms do not provide enough error injection coverage to generate many different errors. Some existing error injection mechanisms are done within a device and without the complete system knowledge leading to poor coverage of the error injection.

In the past, error injection hooks have been provided. However, traditional error injection hooks have been debug hooks that are not provided on a production environment (due to security reasons) on a running OS. In order to verify functioning of RAS features end-to-end, error injection capabilities are needed that are available to the OS and/or VMM at runtime on a production platform.

Additionally, some systems such as Front Side Bus (FSB) systems limit memory protection to a Dual In-Line Memory Module (DIMM) pair. With large memory capacities of QPI based systems today and in the future, however, the ability to migrate memory at a larger granularity is required.

An operation such as Lock Compare Exchange could be used to read and write the data atomically, but this is a slow copy operation and does not allow flexibility for error checking between reads and writes.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

FIG. 4 illustrates a flow according to some embodiments of the inventions.

FIG. 5 illustrates a flow according to some embodiments of the inventions.

FIG. 6 illustrates a flow according to some embodiments of the inventions.

FIG. 7 illustrates a flow according to some embodiments of the inventions.

FIG. 8 illustrates a system according to some embodiments of the inventions.

FIG. 9 illustrates a system according to some embodiments of the inventions.

FIG. 10 illustrates a flow according to some embodiments of the inventions.

FIG. 11 illustrates a flow according to some embodiments of the inventions.

FIG. 12 illustrates a flow according to some embodiments of the inventions.

FIG. 13 illustrates a flow according to some embodiments of the inventions.

FIG. 14 illustrates a flow according to some embodiments of the inventions.

### DETAILED DESCRIPTION

Some embodiments of the inventions relate to dynamic system reconfiguration.

In some embodiments system reconfiguration code and data to be used to perform a dynamic hardware reconfiguration of a system including a plurality of processor cores is cached and any direct or indirect memory accesses during the dynamic hardware reconfiguration are prevented. One of the processor cores executes the cached system reconfiguration code and data in order to dynamically reconfigure the hardware.

Some embodiments related to injecting error in a computing system. Some embodiments relate to migrating memory in a computing system. Some embodiments related to injecting error in a computing system using quiesce mode (and/or Quiesce Mode). Some embodiments relate to migrating memory in a computing system using quiesce mode (and/or Quiesce Mode).

In some embodiments a request is received to perform an error injection or a memory migration, a mode is entered that blocks requests from agents other than a current processor core or thread, the error is injected or the memory is migrated, and the mode that blocks requests from the agents other than the current processor core or thread is exited.

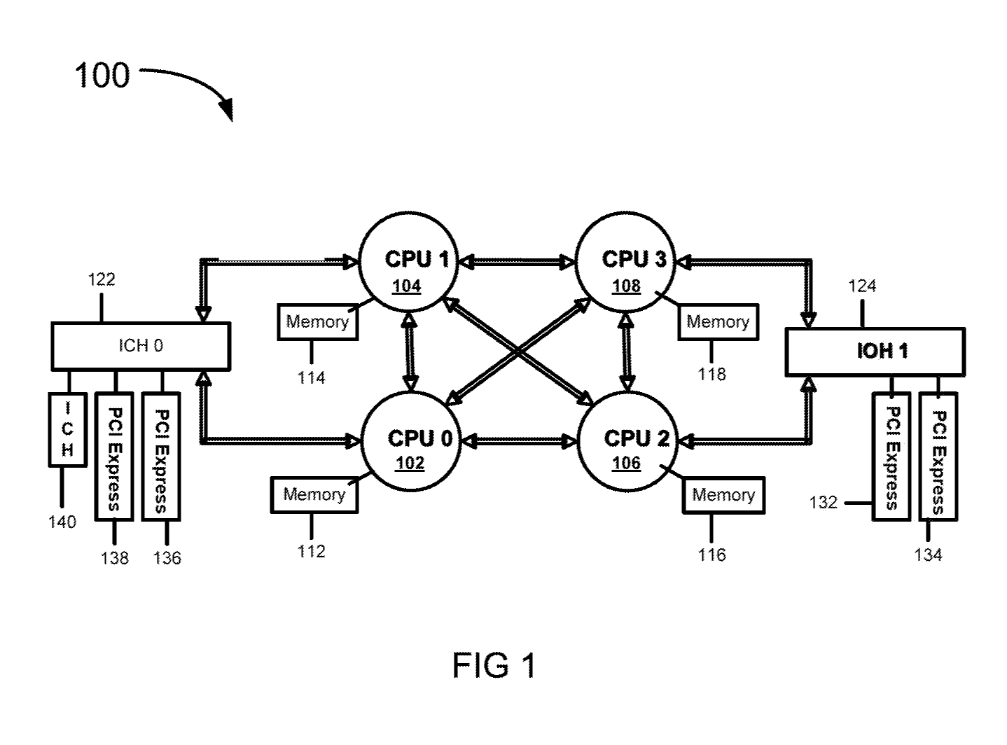

FIG. 1 illustrates a system 100 according to some embodiments. In some embodiments system 100 includes a plurality of processors and/or Central Processing Units (CPUs), including for example CPU0 102, CPU1 104, CPU2 106 and CPU3 108. In some embodiments system 100 additionally includes a plurality of memories, including for example, memory 112, memory 114, memory 116, and memory 118. In some embodiments, each of the processors 102, 104, 106, and 108 has a memory controller. In some embodiments system 100 additionally includes one or more Input/Output Hubs (IOHs), including for example IOH0 122 and IOH1 124. In some embodiments IOH1 124 is coupled to PCI Express bus 132 and/or PCI Express bus 134, and/or IOH0 122 is coupled to PCI Express bus 136, PCI Express bus 138, and/or Input/Output Controller Hub (ICH) 140. In some embodiments the processors 102, 104, 106 and 108 and the IOH 122 and IOH 124 are coupled together by a plurality of links and/or interconnects. In some embodiments, the links and/or interconnects coupling the processors 102, 104, 106 and 108 and the IOH0 122 and IOH1 124 are a plurality of coherent links, such as, for example, in some embodiments, Quick Path Interconnect (QPI) links and/or a plurality of Common System Interface (CSI) links.

In some embodiments, system 100 is a four socket QPI-based system. In some embodiments, QPI components (for example, processor sockets and/or I/O hubs) are connected using Intel QPI links and are controlled through Intel QPI ports. In some embodiments, communication between the QPI components is enabled using Source Address Decoders (SAD) and routers (RTA). A Source Address Decoder (SAD) decodes in-band address access to a specific node address. A QPI Router routes the traffic within the QPI components and to other QPI components.

According to some embodiments, QPI platforms require that all Source Address Decoders and Routers in the system are programmed identically to protect against the misrouting of traffic. During a boot operation, this programming may be accomplished in the Basic Input/Output System (BIOS) before any control is handed over to the operating system (OS).

In some embodiments, after the system is booted to the OS, Reliability, Availability and Serviceability (RAS) events can change the system configuration. For example, RAS events include operations such as processor add, processor remove, IOH add, IOH remove, memory add, memory move, memory migration, memory mirroring, memory sparing, processor hot plug, memory hot plug, hot plug socket, hot plug IOH (I/O hub), domain partitioning, etc. These and other types of RAS events require that QPI components be programmed dynamically while the OS continues to run. They require dynamically changing the system while the OS is running. Due to the requirement that the SAD and the routers be programmed identically at all times, these RAS operations require that any update to QPI configuration be done “atomically” (that is, no coherent traffic must be in progress while the QPI is reconfigured). Additionally, since the OS continues to run during such RAS events, the reconfiguration needs to be accomplished in a narrow time window (for example, typically on the order of hundreds of microseconds) in order to protect against OS timeouts.

High-end RAS features such as, for example, hot plug socket, hot plug processor, hot plug memory, hot plug I/O hub (IOH), hot plug of memory, hot plug of I/O chipset, hot plug of I/O Controller Hub (ICH), online/offline of processor, online/offline of memory, online/offline of I/O chipset, online/offline of I/O Controller Hub (ICH), memory migration, memory mirroring, processor (and/or CPU) migration, domain partitioning, etc. are key differentiators for high-end mission critical multiprocessor server platforms. Server and/or multiprocessor platforms based on a link such as QPI are designed to allow for high-end RAS features such as these, for example. As mentioned above, a common requirement to these RAS flows in QPI based systems is the need to atomically update QPI configuration (for example, QPI routing changes, Source Address Decoder changes, broadcast list, etc.) on all QPI agents (for example, on all processors and I/O Hubs).

In addition to being atomic, these changes need to be done in an OS transparent manner without impacting the running OS. According to some embodiments, a System Management Mode (SMM) is used to accomplish the routing changes using a System Management Interrupt (SMI). Traditional SMI code execution runs out of memory, which could be located on any QPI socket in the system. However, memory accessed during QPI configuration change results in potentially misrouted packets and compromises the integrity of the system unless memory access is prevented during the reconfiguration. Additionally, the SMI latency is limited to the order of hundreds of microseconds due to OS real time access expectations.

According to some embodiments, dynamic QPI system reconfiguration is performed in an atomic manner (that is, no coherent traffic like memory access occurs while reconfiguration is in progress), and meets Operating System/Virtual Memory Manager (OS/VMM) realtime response requirements.

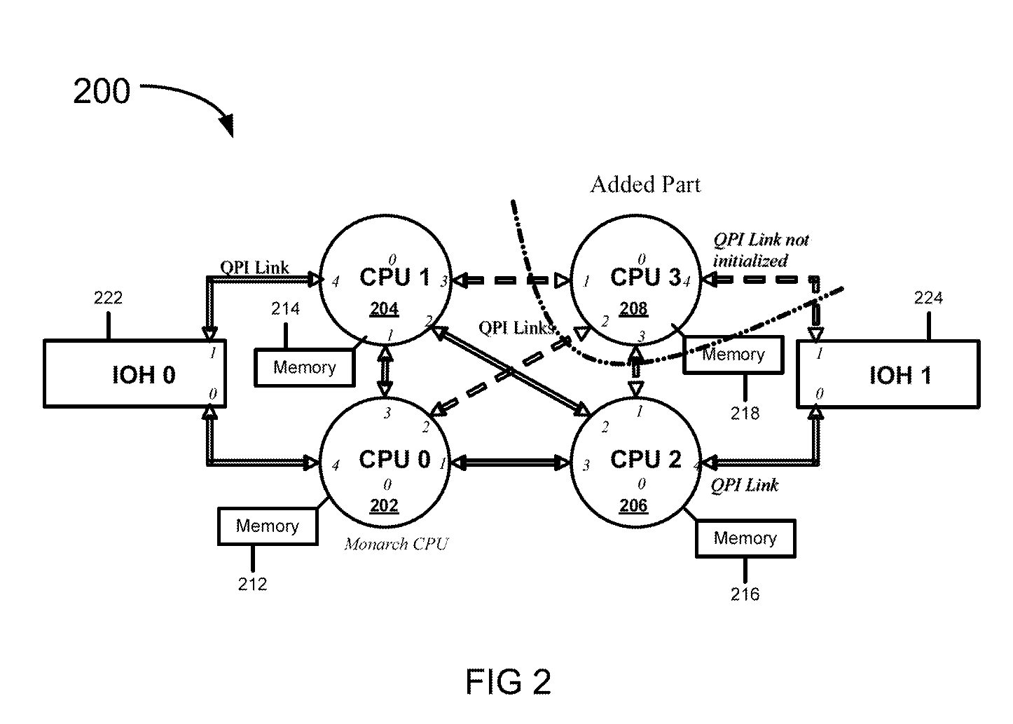

FIG. 2 illustrates a system 200 according to some embodiments. In some embodiments system 200 includes a plurality of processors and/or Central Processing Units (CPUs), including for example CPU0 202, CPU1 204, CPU2 206 and CPU3 208. In some embodiments system 200 additionally includes a plurality of memories, including for example, memory 212, memory 214, memory 216, and memory 218. In some embodiments, each of the processors 202, 204, 206, and 208 has a memory controller. In some embodiments system 200 additionally includes one or more Input/Output Hubs (IOHs), including for example IOH0 222 and IOH1 224. In some embodiments the processors 202, 204, 206 and 208 and the IOH 222 and IOH 224 are coupled together by a plurality of links and/or interconnects. In some embodiments, the links and/or interconnects coupling the processors 202, 204, 206 and 208 and the IOH0 222 and IOH1 224 are a plurality of coherent links, such as, for example, in some embodiments, Quick Path Interconnect (QPI) links and/or a plurality of Common System Interface (CSI) links.

The system 200 of FIG. 2 assumes that the CPU3 208 (and/or the CPU3 108 in the system of FIG. 1) was not present when the system was booted, and that CPU3 208 needs to be hot added to the running system. FIG. 2 illustrates port information for each of the QPI agents 202, 204, 206, 208, 222 and 224 in the system. The links (for example, QPI links) between the other processors 202, 204 and 206 and the IOHs 222 and 224 are shown as initialized and operating links, but the links between the CPU3 208 and the other components are shown in FIG. 2 using dotted lines since those links have not yet been initialized. In order to handle the hot add of CPU3 208, a discovery first needs to be made as to how the running system connects with the added CPU3 208. According to some embodiments, the router (RTA) and Source Address Decoders (SAD) on both the CPU3 208 and all the other QPI components 202, 204, 206, 222, and 224 need to be configured (or reconfigured) so that the CPU3 208 and memory 218 can be added to the running system.

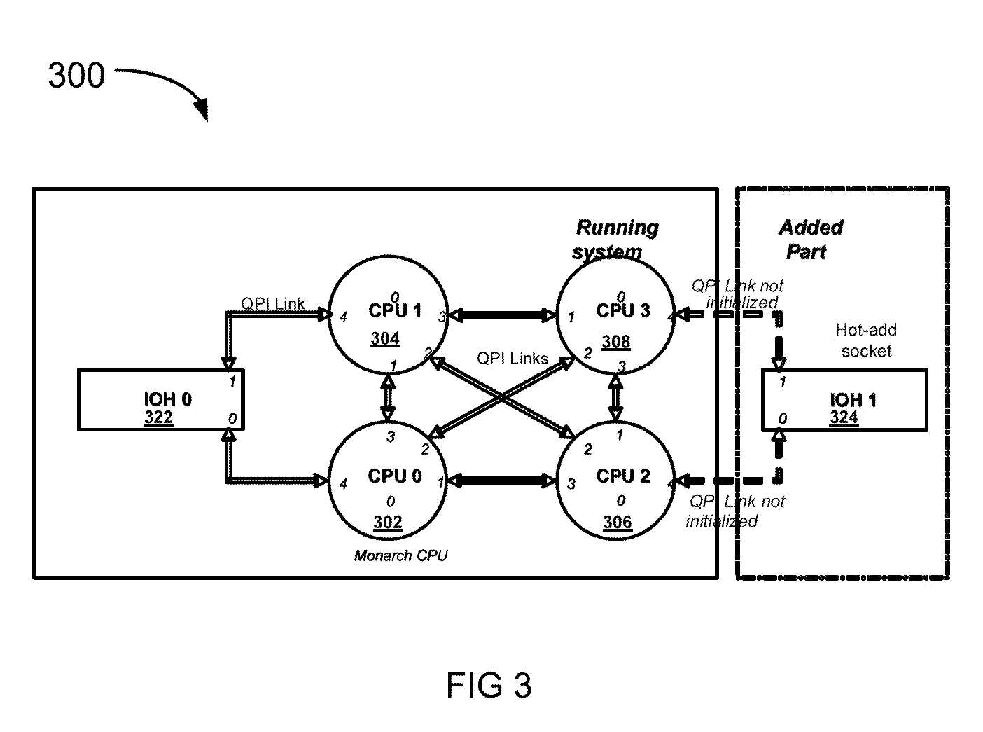

FIG. 3 illustrates a system 300 according to some embodiments. In some embodiments system 300 includes a plurality of processors and/or Central Processing Units (CPUs), including for example CPU0 302, CPU1 304, CPU2 306 and CPU3 308. In some embodiments system 300 additionally includes a plurality of memories, including for example, memory 312, memory 314, memory 316, and memory 318. In some embodiments, each of the processors 302, 304, 306, and 308 has a memory controller. In some embodiments system 300 additionally includes one or more Input/Output Hubs (IOHs), including for example IOH0 322 and IOH1 324. In some embodiments the processors 302, 304, 306 and 308 and the IOH 322 and IOH 324 are coupled together by a plurality of links and/or interconnects. In some embodiments, the links and/or interconnects coupling the processors 302, 304, 306 and 308 and the IOH0 322 and IOH1 324 are a plurality of coherent links, such as, for example, in some embodiments, Quick Path Interconnect (QPI) links and/or a plurality of Common System Interface (CSI) links.

The system 300 of FIG. 3 assumes that the IOH1 324 (and/or the IOH1 124 in the system of FIG. 1 and/or IOH1 224 in the system of FIG. 2) was not present when the system was booted, and that IOH1 324 needs to be hot added to the running system. FIG. 3 illustrates port information for each of the QPI agents 302, 304, 306, 308, 322 and 324 in the system. The links (for example, QPI links) between the processors 302, 304 306, and 308, and the other IOH0 322 are shown as initialized and operating links, but the links between the IOH1 324 and the other components are shown in FIG. 3 using dotted lines since those links have not yet been initialized. In order to handle the hot add of IOH1 324, a discovery first needs to be made as to how the running system connects with the added IOH1 324. The router (RTA) and Source Address Decoders (SAD) on both the IOH1 324 and all the other QPI components 302, 304, 306, 308, and 322 need to be configured (or reconfigured) so that the IOH1 324 can be added to the running system.

According to some embodiments, system reconfiguration code and data are cached, and any direct or indirect access to memory is prevented. In some embodiments, since the system reconfiguration is performed while executing out of a cache, any QPI link route or Source Address Decoder changes sill not affect the code execution.

According to some embodiments, only one processor core is allowed to run during the reconfiguration time windows, and all other cores are blocked from implementing any outbound accesses. In some embodiments, the reconfiguration data is computed outside a Quiesce-Unquiesce window to reduce SMI latency. According to some embodiments, dynamic reconfiguration of a QPI platform is accomplished using a runtime firmware flow using a QPI quiesce operation.

In some embodiments, Quiesce code is cached by reading the Quiesce code from memory. The Quiesce data is cached, and any modification of the data being written back into the memory is prevented by performing a data read and write operation to cause the cache line to be in a modified state. Prefetch is disabled to avoid memory accesses during the system reconfiguration code execution. Speculative loads and/or prefetch from memory are not made by avoiding all address regions other than the Quiesce code and data. The uncore is flushed to make sure that all outstanding transactions are completed before performing any system reconfiguration operation. All other threads are synchronized in the system reconfiguration code executing in the core to make sure that they are executing out of the cache. All out of band (OOB) debug hooks are stopped during the system reconfiguration window.

According to some embodiments, QPI components support a Quiesce mode by which normal traffic is paused by all the QPI agents except the quiesce. According to some embodiments, a definition of a Quiesce Model Specific Register (MSR) of a processor is shown below. This register may be used according to some embodiments for software to initiate Quiesce, UnQuiesce, and UnCore Fence operations through the processor MSR.

| Bit | Default | |
|---|---|---|
| 2 | 0 | Uncore Fence. Flushes out all outstanding uncore |
| | | transactions issued by the core on which the MSR |
| | | wr [symbol] executed, as well as any cache side |
| | | effects of those transactions. |
| | | 1 - Uncore Fence |
| | | 0 - No change |
| 1 | 0 | UnQuiesce. Initiates the UnQuiesce operation of the |
| | | system. All the QPI agents listed in the broadcast list |
| | | allowed to resume operation. |
| | | 1 - Exit Quiesce state |
| | | 0 - No change |
| 0 | 0 | Quiesce. Initiates the Quiesce operation of the |
| | | syste [symbol] the QPI agents listed in the broadcast |
| | | list enter the Quiesce state. |
| | | 1 - Enter Quiesce state |
| | | 0 - No change |

[symbol]

indicates data missing or illegible when filed

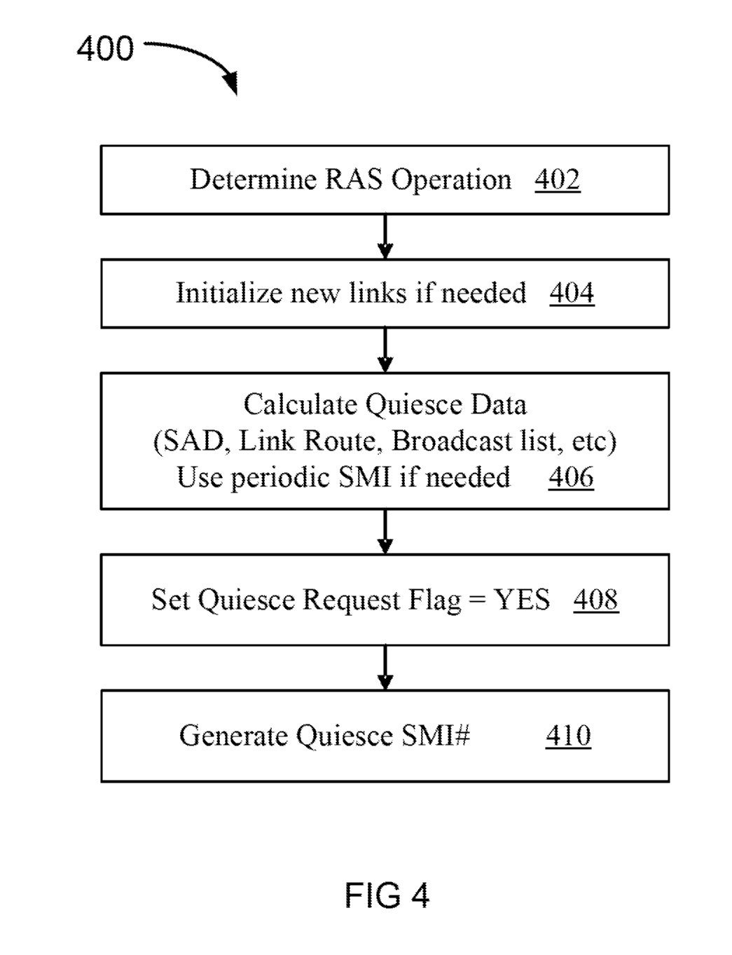

FIG. 4 illustrates a flow 400 according to some embodiments. In some embodiments, flow 400 is a Quiesce data generation flow. First, a RAS operation is determined and/or identified at 402. Then new links (for example, QPI links) are initialized at 404, if necessary. Then Quiesce data such as, for example, SAD, Link Route (and/or QPI Route), Broadcast list, etc. is calculated at 406 (for example, using a periodic SMI if needed). At 408 a Quiesce Request Flag is set. Then a Quiesce SMI# is generated at 410.

In some embodiments, only one processor core (for example, a “Monarch” processor) is allowed to run during the reconfiguration windows and all other cores are blocked from any outbound accesses. In some embodiments the reconfiguration data is computed outside the Quiesce-UnQuiesce window to reduce the SMI latency.

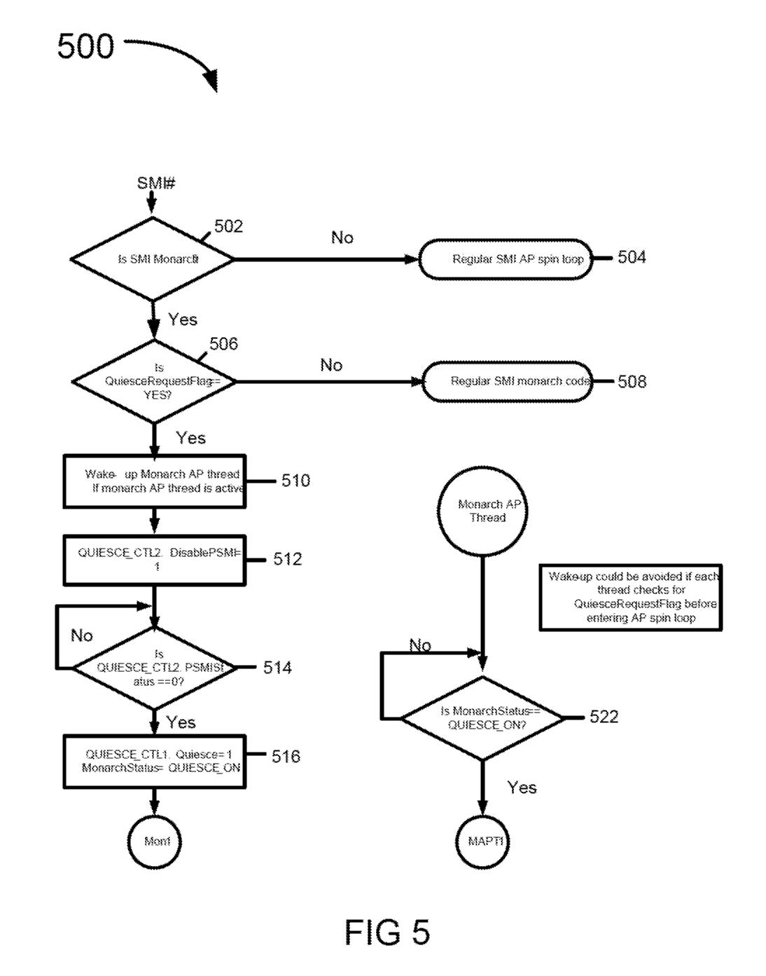

FIGS. 5, 6 and 7 illustrate flows 500, 600, and 700 according to some embodiments. In some embodiments, flows 500, 600, and 700 illustrates a flow to accomplish dynamic reconfiguration of a platform such as a QPI platform. In some embodiments, flows 500, 600, and 700 use a runtime firmware flow implementing a QPI quiesce.

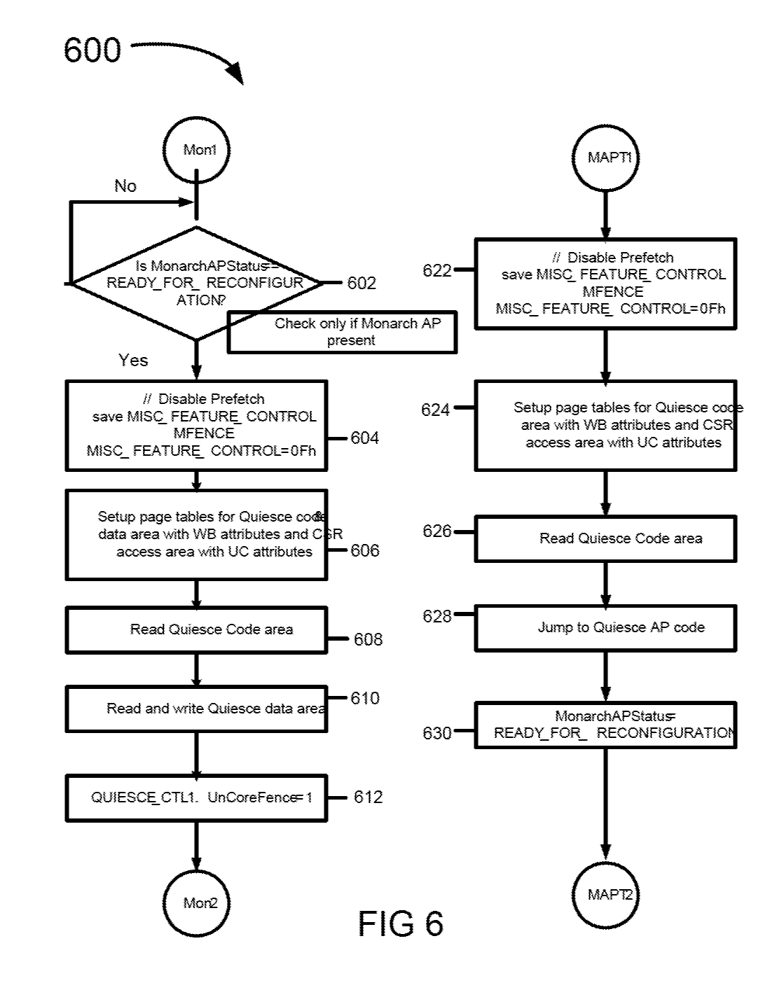

The Quiesce Monarch core is selected out of all the available cores in the system to carry out the Quiesce, system reconfiguration, and UnQuiesce operations. The Quiesce core might have multiple threads. Each of the Quiesce core threads need to make sure that it does not access any memory during the reconfiguration operation. This operation is outlined, for example, as a Monarch AP (Application Processor—i.e. non-monarch processor) thread in FIGS. 5, 6, and/or 7, for example.

At 502 of FIG. 5 a determination is made as to whether the SMI is running on the Monarch QPI agent (for example, a Monarch processor) identified as the one processor allowed to run during reconfiguration. If it is not an SMI Monarch at 502 then a regular SMI AP (Application Processor—i.e. non-monarch processor) spin loop is performed at 504. If it is an SMI Monarch at 502 then a determination is made at 506 as to whether a Quiesce Request Flag is set. If the Quiesce Request flag is not set at 506 then regular SMI Monarch code is performed at 508. However, if the Quiesce Request flag is set at 506 then a wake-up Monarch AP thread is implemented at 510 (for example, if the Monarch AP thread is active). In some embodiments, wake up could be avoided if each thread checks for the Quiesce Request Flag before entering the AP spin loop.

The Quiesce Monarch disables any outside agents' access to the memory or Configuration Spare Registers (CSR) at 512. The RTA and SAD are normally implemented as CSR so that access to the CSR during the reconfiguration phase might result in proving wrong contents. This is accomplished in some embodiments by configuring implementation specific MSR or by requesting out of band (OOB) devices such as, for example, a Baseband Management Controller (BMC), a System Service Processor (SSP), and/or a Management Engine (ME). The outside agents' access to memory or CSR at 512 can be implemented in some embodiments, for example, by disabling processor debug hooks or by disabling access through processor side-band interfaces. A determination is made at 514 as to whether the outside agents' CSR access has been disabled. If it has not been disabled at 514 then flow in that thread remains at 514 until it has been disabled. Once it has been determined that the outside agents' CSR access has been disabled at 514 the Quiesce operation is initiated at 516 by setting the Quiesce bit in the QUIESCE_CTL register (for example, by setting QUIESCE_CTL1.Quiesce=1), and in some embodiments setting MonarchStatus to “QUIESCE_ON”. This operation makes sure that all the QPI agents enter the Quiesce state and do not initiate any new transactions. In the Monarch AP thread flow remains at 522 until a determination is made that MonarchStatus has been set to “QUIESCE_ON”. Flow from 516 moves to “Mon1” in FIG. 6 and flow from 522 moves to “MAPT1” in FIG. 6.

Once the system is in the Quiesce state, as shown in the Monarch thread flow in FIG. 6, the Monarch thread caches both code and data and starts executing out of cache with no exterminal memory access. At 602 a determination is made as to whether MonarchAPStatus is “READY FOR RECONFIGURATION”. This is checked in some embodiments only if the Monarch AP is present. Once the Monarch AP Status is “READY FOR RECONFIGURATION” a disable prefetch operation occurs at 604. In some embodiments this is accomplished at 604 by saving a MISC_FEATURE_CONTROL, then performing an “MFENCE” (Memory Fence—for example, a serializing operation that guarantees that every load and store instruction that precedes in program order the MFENCE instruction is globally visible before any load or store instruction that follows the MFENCE instruction is globally visible) and/or then setting MISC_FEATURE_CONTROL to 0Fh. In some embodiments, this is accomplished at 604 by saving prefetch controls, MFENCE, and disabling prefetch. At 606 page tables for Quiesce code and data area are set up with WB (Write Back caching attribute) attributes and CSR access area with UC (Uncached caching attribute) attributes. The page tables are set up such that there are no speculative loads and/or prefetch outside the Quiesce code area. The page tables are set up such that only the Quiesce code area is UC. This indirectly makes sure that the speculative loads and/or prefetch are not performed outside the Quiesce code area. At 608 the Quiesce code area is read to cache the code. At 610 a read and write of the Quiesce data area is performed. In some embodiments (not illustrated in FIG. 6), a jump to cached code is then performed (for example, a jump to Quiesce Monarch Code). At this step the code is executed out of cache, not from memory. At 614 an UnCoreFence bit is set (for example, QUIESCE_CTL1.UnCoreFence=1).

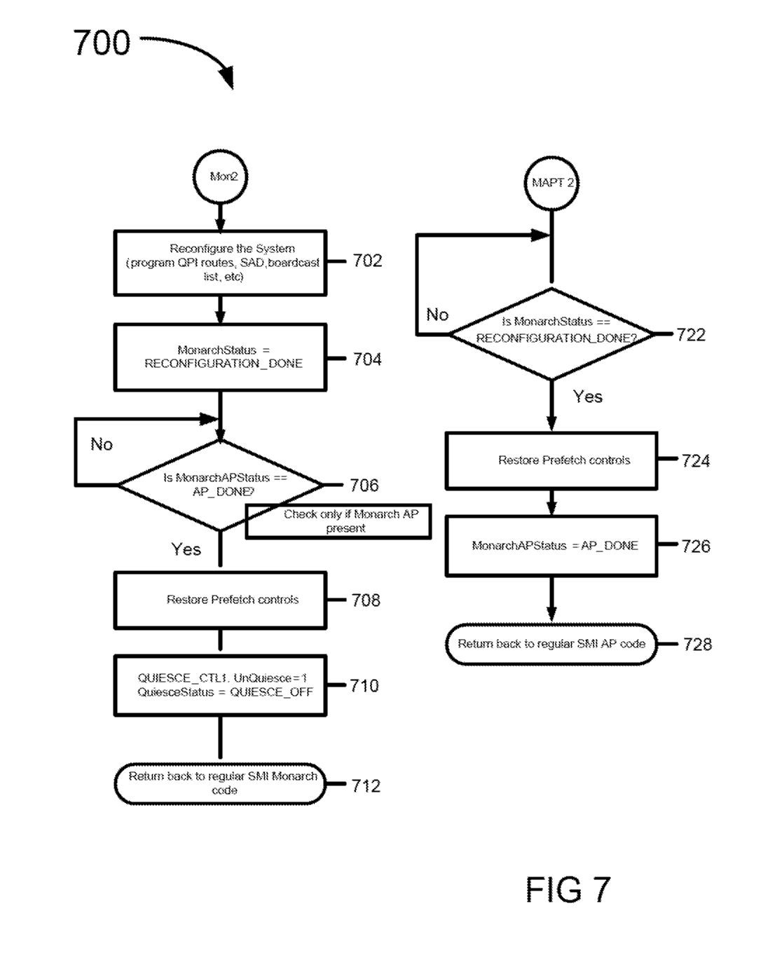

The Quiesce Monarch code is used in FIG. 6 to cache the Quiesce code and data. For example, a disable prefetch operation occurs at 622. In some embodiments, prefetch controls are saved, MFENCE, and prefetch is disabled. In some embodiments this is accomplished at 622 by saving a MISC_FEATURE_CONTROL, then performing an “MFENCE” (Memory Fence) and/or then setting MISC_FEATURE_CONTROL to 0Fh. At 624 page tables are set up for the Quiesce code area with WB attributes and CSR access area with UC attributes. The page tables are set up such that there are no speculative loads and/or prefetch outside the Quiesce code and data area. The page tables are set up such that only the Quiesce code and data areas are UC. This indirectly ensures that speculative loads and/or prefetch are not performed outside of the Quiesce code and data area. At 626 the Quiesce code area is read to cache the code. The Quiesce data area is read and written to in order to cache the data in the modified state. This makes sure that any Quiesce data accesses during the system reconfiguration do not cause memory access. At 628 a jump to the Quiesce Monarch code (and/or the Quiesce AP code) is implemented. At this step the code is executed out of cache. At 630 MonarchAPStatus is set to “READY FOR RECONFIGURATION”. Flow from 614 moves to “Mon2” in FIG. 7 and flow from 630 moves to “MAPT2” in FIG. 7. An UnCore fence is performed to make sure that all outstanding transactions, including cache victim traffic, from the cores, uncore, and sockets are drained. At this point all code and data accesses are from cache and no memory accesses are performed.

According to some embodiments the Monarch Quiesce is to reconfigure the system by programming RTA, SAD, etc. on each socket. The system is set to UnQuiesce and all cores can continue from previously paused locations. Prefetches and outside agents' CSR accesses are restored. This is accomplished, for example, according to FIG. 7. At 702 the system is reconfigured (for example, by programming QPI routes, SAD, Broadcast list, etc). At 704 Monarch Status is set to “RECONFIGURATION DONE”. A determination is made at 706 as to whether MonarchAPStatus is “AP_DONE”. In some embodiments, this is checked only if the Monarch AP is present. Once it is determined at 706 that the Monarch AP Status is “AP DONE” prefetch controls are restored at 708. At 710 the “QUIESCE_CTL1.UnQuiesce” bit is set to “1” and the “QuiesceStatus” is set to “QUIESCE_OFF”. Then a return back to regular SMI Monarch code is performed at 712.

At 722 a determination is made as to whether MonarchStatus is set to “RECONFIGURATION DONE”. Once it is, prefetch controls are restored at 724. At 726 MonarchAPStatus is set to “AP_DONE”. Then a return back to regular SMI AP code is performed at 728.

Systems with coherent links such as QPI, multiple processors (MP), multiple memory controllers, and multiple chipsets are being designed and becoming more and more common. Advanced RAS features including but not limited to processor hot plug, processor migration, memory hot plug, memory mirroring, memory migration, and memory sparing will become commonplace in the server market segments. RAS features demand a lot of work to be done by the Basic Input/Output System (BIOS) during runtime. According to some embodiments, system reconfiguration is implemented without requiring expensive hardware hooks.

Quick Path Interconnect (QPI) (and/or CSI) based server systems introduce advanced RAS features including but not limited to processor hot plug, memory hot plug, memory mirroring, memory migration, memory sparing, etc. These features require dynamically changing the system configuration while the operating system (OS) is running. These operations are currently implemented using System Management Interrupt (SMI), where the SMI brings all the processors together, performs a quiesce of API agents (such as processors, IOHs, etc.), and reprograms the system configuration (such as QPI routes, address decoders, etc). However, the SMI executes out of memory, which cannot be tolerated during QPI route changes. Therefore, in some embodiments, the SMI handler code and data is loaded into cache and executed out of it. This makes the runtime configuration flow very cache architecture dependent. Additionally, caching code and reprogramming QPI routes and address decoders by SMI code execution would take a considerable amount of time. Due to OS restriction on SMI latency, the SMI Quiesce and QPI programming code need to be written carefully with stringent timing constraints to meet latency requirements. These factors make previous quiesce flow quite complicated, and hard to code and validate.

According to some embodiments, a shadow register allows hardware to perform the Quiesce operation and change the system configuration without executing any BIOS and/or SMI code under Quiesce. This allows for a fast change to the system configuration, low SMI latency (or no SMI latency), and removes the dependency on the processor cache architecture and associated complications.

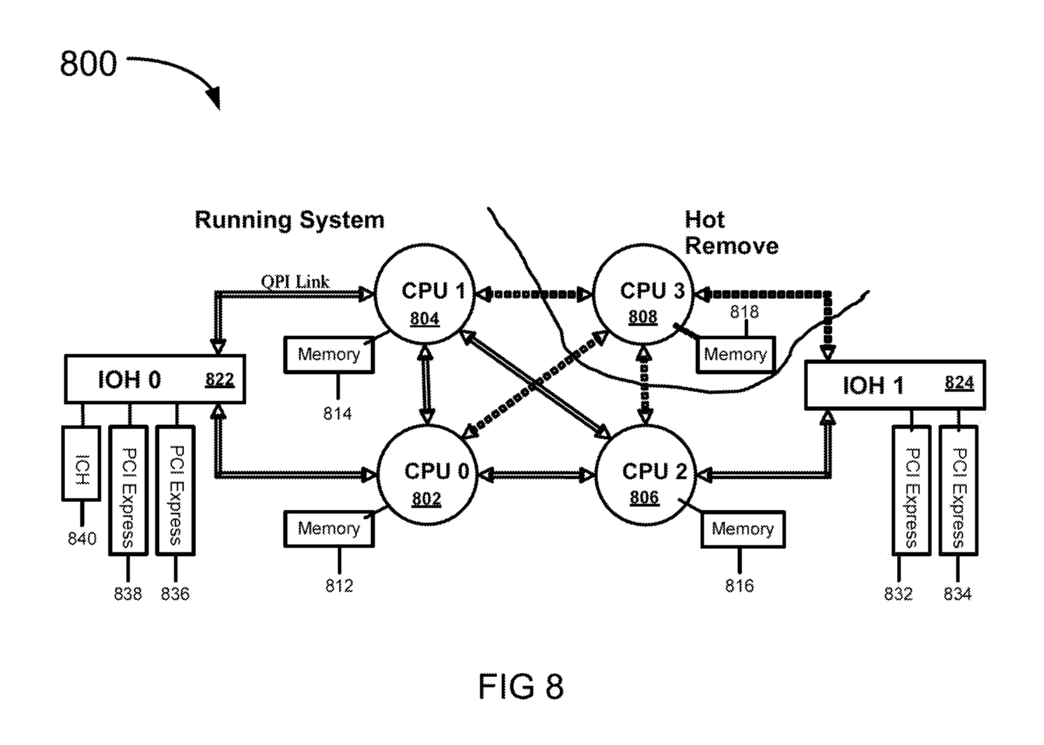

FIG. 8 illustrates a system 800 according to some embodiments. In some embodiments system 800 includes a plurality of processors and/or Central Processing Units (CPUs), including for example CPU0 802, CPU1 804, CPU2 806 and CPU3 808. In some embodiments system 800 additionally includes a plurality of memories, including for example, memory 812, memory 814, memory 816, and memory 818. In some embodiments, each of the processors 802, 804, 806, and 808 has a memory controller. In some embodiments system 800 additionally includes one or more Input/Output Hubs (IOHs), including for example IOH0 822 and IOH1 824. In some embodiments the processors 802, 804, 806 and 808 and the IOH 822 and IOH 824 are coupled together by a plurality of links and/or interconnects. In some embodiments, the links and/or interconnects coupling the processors 802, 804, 806 and 808 and the IOH0 822 and IOH1 824 are a plurality of coherent links, such as, for example, in some embodiments, Quick Path Interconnect (QPI) links and/or a plurality of Common System Interface (CSI) links.

The system 800 of FIG. 8 assumes that the CPU3 808 (and/or the CPU3 108 in the system of FIG. 1) was present when the system was booted, but is to be hot removed from the running system. The links (for example, coherent links and/or QPI links) between the other processors 802, 804 and 806 and the IOHs 822 and 824 are shown as initialized and operating links, but the links between the CPU3 808 and the other components are shown in FIG. 8 using dotted lines since those links need to no longer be active after the hot removal of CPU3 808. In order to handle the hot removal of CPU3 808, the OS will need to stop using the CPU3 808 and the memory 818 coupled to CPU3 808. The system must be quiesced, the CPU3 808 address routing in all sockets must be removed, and the link routing (for example, QPI routing) to CPU3 808 must be removed in all sockets. Then the system needs to be un-quiesced in order to continue the OS.

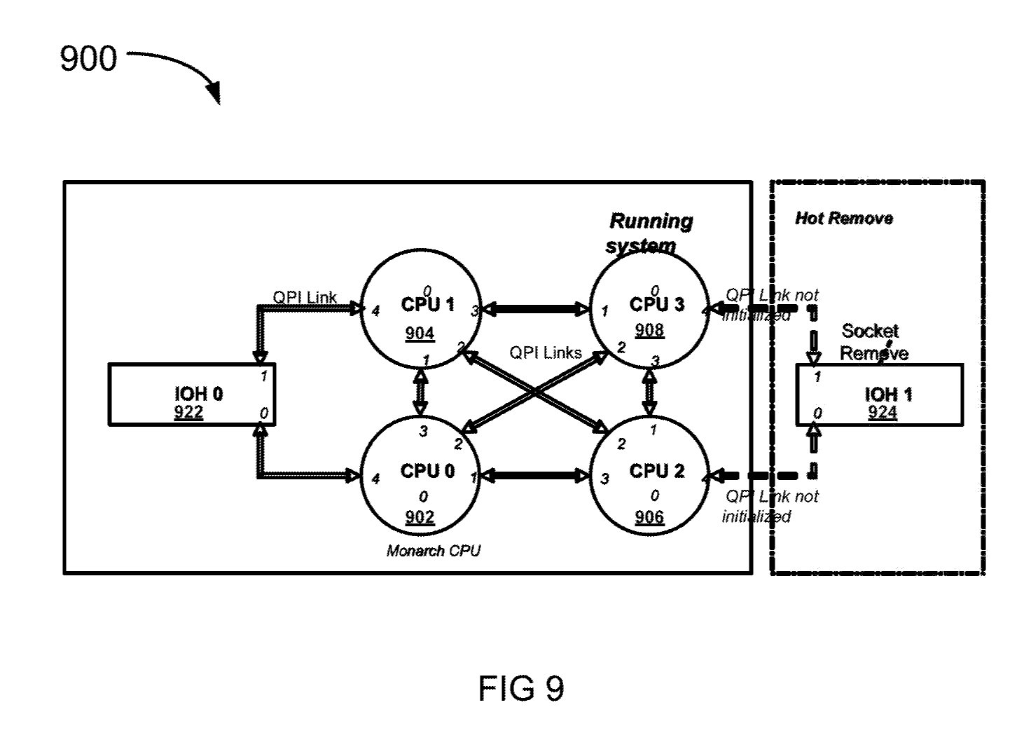

FIG. 9 illustrates a system 900 according to some embodiments. In some embodiments system 900 includes a plurality of processors and/or Central Processing Units (CPUs), including for example CPU0 902, CPU1 904, CPU2 906 and CPU3 908. In some embodiments system 900 additionally includes a plurality of memories, including for example, memory 912, memory 914, memory 916, and memory 918. In some embodiments, each of the processors 902, 904, 906, and 908 has a memory controller. In some embodiments system 900 additionally includes one or more Input/Output Hubs (IOHs), including for example IOH0 922 and IOH1 924. In some embodiments the processors 902, 904, 906 and 908 and the IOH 922 and IOH 924 are coupled together by a plurality of links and/or interconnects. In some embodiments, the links and/or interconnects coupling the processors 902, 904, 906 and 908 and the IOH0 922 and IOH1 924 are a plurality of coherent links, such as, for example, in some embodiments, Quick Path Interconnect (QPI) links and/or a plurality of Common System Interface (CSI) links.

The system 900 of FIG. 9 assumes that the IOH1 924 (and/or the IOH1 124 in the system of FIG. 1) was present when the system was booted, but is to be hot removed from the running system. The links (for example, coherent links and/or QPI links) between the processors 902, 904, 906, and 908, and the other IOH0 922 are shown as initialized and operating links, but the links between the IOH1 924 and the other components are shown in FIG. 9 using dotted lines since those links need to no longer be active after the hot removal of IOH1 924. In order to handle the hot removal of IOH1 924, the OS will need to stop using the IOH1 924. The system must be quiesced, the IOH1 924 address routing in all sockets must be removed, and the link routing (for example, QPI routing) to IOH1 924 must be removed in all sockets. Then the system needs to be un-quiesced in order to continue the OS.

In some embodiments, each agent (for example, each QPI agent) provides a set of shadow registers for the link routing (for example, QPI routing), the address decoder, the broadcast list, and any other register that would impact the system reconfiguration. In order to perform the configuration change, in some embodiments the shadow registers are programmed with software with the new configuration registers, and the software initiates the hardware request to perform the configuration switch. The new configuration takes effect as soon as the configuration switch is completed.

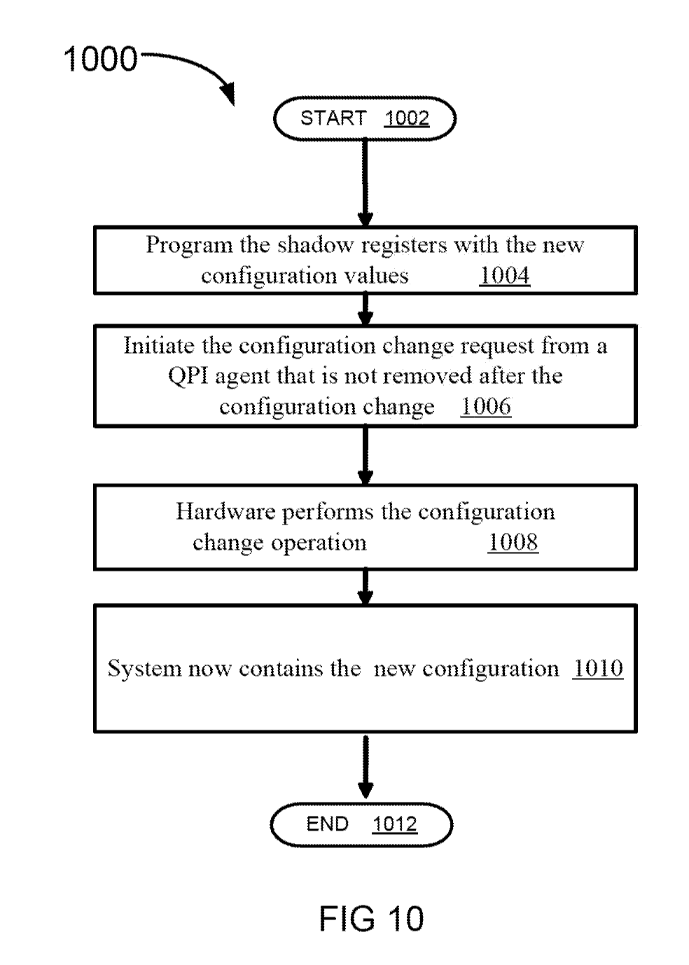

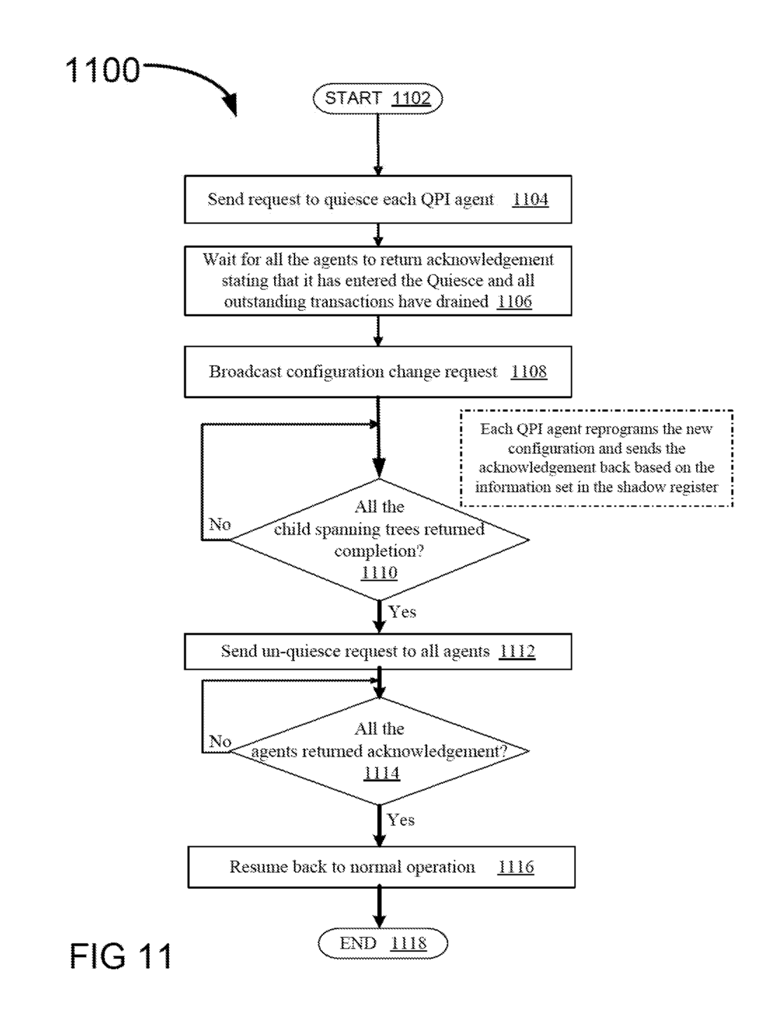

FIG. 10 illustrates a flow 1000 according to some embodiments. In some embodiments flow 1000 is a configuration change software flow. Flow 1000 starts at 1002. At 1004 the shadow registers are programmed with a new set of configuration values. At 1006 the configuration change request is initiated from an agent such as a QPI agent that is not removed after the configuration change. The configuration change is initiated by writing to a hardware register such as a Model Specific Register (MSR) or a Configuration Space Register (CSR). At 1008 the hardware performs the configuration change operation. In some embodiments, the hardware performs the configuration change operation at 1008, for example, in a manner similar to or the same as the flow 1100 illustrated in FIG. 11 and described in further detail below. The hardware performs the Quiesce and switches to the new configuration registers based on the shadow registers (for example, in some embodiments, as further illustrated in FIG. 11 and described below). At 1010 the system now contains the new configuration, and system operation can now continue with the new configuration. Flow 1000 ends at 1012.

FIG. 11 illustrates a flow 1100 according to some embodiments. In some embodiments, flow 1100 represents a hardware configuration change flow. Flow 1100 starts at 1102. A request is sent at 1104 to quiesce each QPI agent (or other type of agent in some embodiments). This blocks Direct Memory Access (DMA), and blocks any new transaction generation from any QPI agent other than the Quiesce initiating agent. In some embodiments, a poll is made for all outstanding transactions to have completed. At 1106 flow 1100 waits for all of the QPI agents to return an acknowledgement stating that the agent has entered the Quiesce, and all outstanding transactions have been drained. A request is made for all QPI agents to reprogram the register set (and/or the new configuration) from the shadow registers (and/or switch the register set to the shadow registers). An acknowledgement is sent back base on the information set in the shadow register, for example. In some embodiments, the register data contains who to respond to based on a spanning tree. Further information about how this occurs in some embodiments may be found, for example, in U.S. patent application Ser. No. 11/011,801, published as U.S. Patent Publication US-2006-0126656-A1 on Jun. 15, 2006 and entitled “Method, System, and Apparatus for System Level Initialization”.

At 1108 a configuration change request is broadcast. A determination is made at 1110 as to whether all of the child spanning trees have returned completion. In some embodiments, an acknowledgement is made that the system reconfiguration is complete. Once all the child spanning trees have returned completion at 1110, an UnQuiesce request is sent to all QPI agents (and/or new agents) at 1112. At 1114 a determination is made as to whether all the agents (and/or new agents) returned acknowledgement. Once all the agents (and/or new agents) have returned acknowledgement at 1114 normal operation is resumed at 1116. This unblocks DMA and allows transactions to continue (for example, by returning to the execution code).

In some embodiments, shadow (and/or duplicate) registers hold the new configuration information. In some embodiments, initiation of the configuration change is implemented by software. In some embodiments, hardware performs a system quiesce and swiches the shadow configuration to a current configuration, and also performs an un-quiesce to then continue the system operation. In some embodiments, hardware performs checks to make sure all the QPI agents are in quiesce state before initiating the configuration register switch operation. In some embodiments, shadow registers containing a spanning tree are used to return data back after the reconfiguration.

Current server systems implement an MSR based mechanism to initiate Quiesce and UnQuiesce. The SMI code needs to bring all the processors to rendezvous and initiate the quiesce. The SMI needs to cache the code and data, and needs to make sure prefetch and speculative loads are prevented before it changes the system (processors do not provide direct control to disable speculative loads and/or prefetch, so complex uncached and cached code setting sequences are required). Otherwise, memory access, snoops, prefetches and speculative loads would cause SMI code/data access issues during QPI route changes and result in system error. Validation of the SMI code and other settings involved in making the feature are very complex and may cause the SMI latency to exceed OS allowed time limits for SMI.

In some embodiments a shadow register set is used which can be computed and programmed outside the SMI and/or Quiesce/UnQuiesce time window. Additionally, the shadow register switch is done by the hardware rather than the complex software flow. This helps to reduce SMI latency.

Some embodiments do not depend on code and/or data caching behavior, and are therefore architecture independent.

In some embodiments, a scalable solution is provided since the shadow register switch occurs in hardware, and each of the QPI agents contains the shadow register set. Existing SMI based solutions require all the threads in SMI. As the number of QPI agents and/or cores increases, it takes a long time to complete the operation and the OS SMI latency requirement is violated. In some embodiments, a solution is more extensible from one generation to another and is scalable (for example, scalable across wayness).

In some embodiments, out-of-band (OOB) firmware (for example, such as the System Service Processor or SSP) is allowed to change the system configuration without exceeding the OS latency limit even when using slow sideband interface. The SSP cannot change the runtime system configuration when using previously existing solutions.

Current QPI solutions (which are key to support of RAS features on QPI platforms) are cache architecture dependent, are quite complex, and are hard to validate, and firmware handlers need to be hand tuned to fit within the OS latency requirements. Other alternatives such as running quiesce and reprogramming QPI routes and address decoders from direct connected flash are very slow and violate OS requirements for SMI latency. These problems are overcome according to some embodiments. In some embodiments, the programming of shadow registers is not done within the quiesce period, thus reducing the latency for quiesce as well as the complexity of the firmware performing the quiesce and system configuration change flow. According to some embodiments, dependencies on cache architecture are eliminated and the need for complex firmware flow is removed.

In some embodiments, a configuration change is performed by hardware, and no software intervention is required during the configuration change. In this manner, the total latency relating to changing the system configuration is much lower than existing solutions, and a real time response to the end user is enabled.

As described herein, support for high-end RAS features including but not limited to hot plug of processor, memory, onlining/offlining, etc. are key for platforms in the high-end server market segment. An effective QPI operation is required to implement these RAS flows. Current QPI quiesce flow for RAS is processor generation specific due to cache architecture dependencies, since the quiesce code has to run from cache without generating external memory accesses/snoops/speculative loads/prefetches, etc. Such a flow is extremely complicated to code and hard to validate, and may therefore severely limit RAS support on QPI. In some embodiments, a simpler quiesce solution is used that is independent of processor cache architecture. Additionally, support for high-end RAS features is enabled on QPI platforms that scales well for larger multiprocessor (MP) platforms.

Computer systems have been built with error detection, error correction, error recovery and error logging capabilities for a better Reliability, Availability and Serviceability (RAS) experience. One advance in this area is Machine Check Architecture (MCA) error recovery (for example, cache error or memory error recovery used by Intel 7500-series Xeon processors). It is important for Operating System Vendors (OSVs) and/or Virtual Machine Vendors (VMVs) to verify that the error recovery on platforms work as expected by the Operating System (OS) and/or Virtual Machine Monitor (VMM). This verification allows for the OS and/or VMM to ensure that the error recovery and RAS features do indeed work end-to-end. In the past, error injection hooks have been provided. However, traditional error injection hooks have been debug hooks that are not provided on a production environment on a running OS. In order to verify, error injection capabilities are needed that are available to the OS and/or VMM at runtime on a production platform. In some embodiments, error injection is enabled in a production based computer system.

During error injection and especially during memory error injection, if any direct memory access (DMA) traffic from an Input/Output (I/O) subsystem or processor subsystem occurs, it may consume the error immediately rather than having the OS and/or VMM consume the error. This may result in unintended error consumptions by the DMA or in a worst case cause unintended errors. In some embodiments, traffic from the I/O interconnect to the processor and memory subsystems is paused. Additionally, the traffic from all of the processors except the processor core injecting the error is also paused.

According to some embodiments, the OS and/or VMM requests that the Basic Input/Output System (BIOS) seed the error injection, and the BIOS then enters System Management Mode (SMM). The BIOS then brings all of the processor threads into SMM. A Quiesce is then initiated by writing to the processor specific Quiesce register. This blocks any new requests from I/O and all other processor cores and memory. The required error is then seeded (this step is error injection specific in some embodiments). Then an UnQuiesce of the system is performed by writing to the processor specific UnQuiesce register. This unblocks the I/O, processor and memory requests. Then SMM is exited and flow returns to the OS.

According to some embodiments, traffic from all other devices is stopped by performing a Quiesce operation before error injection. Existing error injection mechanisms do not provide enough error injection coverage to generate many different errors as in some embodiments of the inventions. Some existing error injection mechanisms are performed within a device and without complete system knowledge. This leads to poor coverage of the error injection.

According to some embodiments, Quiesce of the system is performed to make sure there is no traffic during the error seeding. Current solutions are unable to stop the traffic during error seeding so the error could be consumed immediately rather than when it is needed. Since error seeding (or error injection) is done within the SMM, if the error is consumed immediately it may result in a fatal error. For example, recoverable error consumption will result in MCA. However, if MCA happens while in SMM it will become a fatal error.

According to some embodiments, error injection performs Quiesce of all the traffic. The Quiesce is performed to bring the system to a known state before injecting the error.

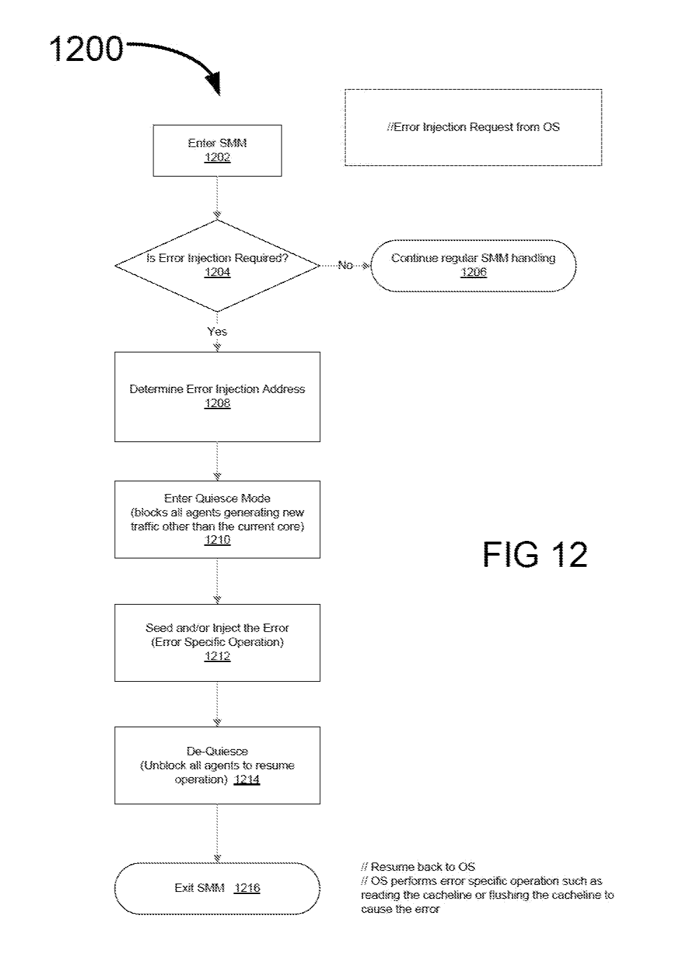

FIG. 12 illustrates a flow 1200 according to some embodiments. In some embodiments, flow 1200 represents an error injection flow. Flow 1200 starts at 1202 where it enters System Management Mode (SMM), for example, in response to an error injection request from the Operating System (OS). At 1204 a decision is made as to whether or not error injection is required. If error injection is not required at 1204, then regular SMM handling is continued at 1206. If error injection is required at 1204, then an error injection address is determined at 1208. At 1210 Quiesce mode is entered, blocking all agents other than the current core from generating new traffic. At 1212 the error is seeded. In some embodiments, this is an error specific operation. At 1214 a de-Quiesce operation occurs to unblock all agents and resume operation. Then SMM is exited at 1216 with a resume back to the OS. At this point the OS performs an error specific operation such as reading the cacheline or flushing the cacheline to cause the error.

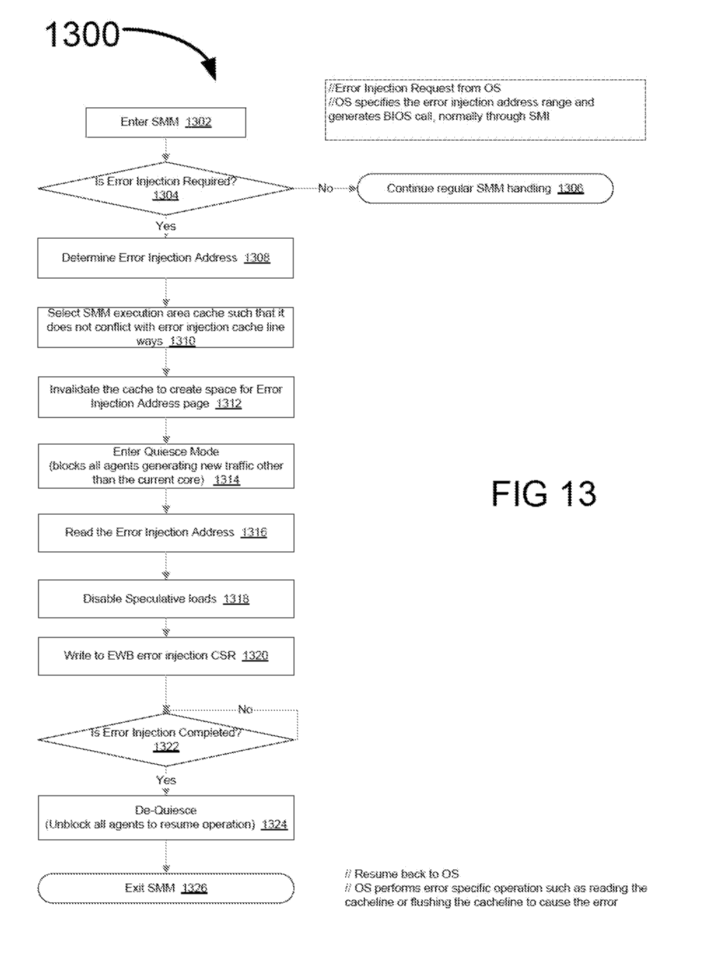

FIG. 13 illustrates a flow 1300 according to some embodiments. In some embodiments, flow 1300 represents an explicit write back error injection flow. Flow 1300 starts at 1302 where it enters System Management Mode (SMM), for example, in response to an error injection request from the Operating System (OS). The OS specifies the error injection address range and generates a BIOS call (normally through a System Management Interrupt or SMI). At 1304 a decision is made as to whether or not error injection is required. If error injection is not required at 1304, then regular SMM handling is continued at 1306. If error injection is required at 1304, then an error injection address is determined at 1308. At 1310 an SMM execution area cache is selected such that it does not conflict with error injection cache line operations. The cache is invalidated at 1312 to create space for the error injection address page. At 1314 the flow enters Quiesce mode and blocks all agents other than the current core from generating new traffic. The error injection address is read at 1316. Speculative loads and/or prefetches are disabled at 1318. At 1320 a write is performed to the Explicit Write Back (EWB) error injection Control and Status Register (CSR). At 1322 a decision is made as to whether error injection has been completed. Once it is determined at 1322 that error injection has been completed a de-Quiesce is performed at 1324 to unblock all agents and resume operation. SMM is then exited at 1326 with a resume back to the OS. The OS then performs error specific operation such as reading the cacheline or flushing the cacheline to cause the error.

According to some embodiments, Explicit Write Back (EWB) Error Injection is performed according to one or more (or all) of the following steps:

1. The OS specifies the error injection address

2. The OS communicates the error injection address to the BIOS (for example, by generating SMM)

3. The BIOS selects an SMM code running area such that the error injection address cache and the SMM execution cache do not overlap

4. The cache is invalidated (for example, by performing WBINVD)

5. Enter Quiesce Mode—Entering Quiesce mode blocks any new transactions from other processor cores, memory and I/O traffic

6. Flush the cache line in which the error will be injected (for example, CLFLUSH)

7. Read the physical address of the error injection address to bring the line in to the cache as an exclusive state (“E” state)

8. Disable speculative loads and/or prefetches (for example, by clearing the CD bit)

9. BIOS writes to the processor specific EWB Error Injection CSR with the error injection address

10. BIOS polls for error injection CSR until injection is complete

11. BIOS enables the cache (for example, by turning on the CD bit)

12. De-Quiesce the system—this resumes traffic from I/O, memory and all other processor cores

13. BIOS returns to the OS by exiting the SMM

14. OS performs cache line flush (CLFLUSH) on the error injection address. This causes the error to be consumed by the OS

15. OS gets MCA—the OS can now perform error recovery

Previously known techniques provide single bit and multi-bit memory error injection and few other simple error cases only in a debug environment. It was not possible to provide error injection support on production platforms with locked processors such that the error injection was available to the OS and/or the VMM at runtime in a production environment. Previous implementations also didn't provide OS recoverable errors and errors such as, for example, patrol scrub, memory poison and explicit write back errors were treated as fatal errors. According to some embodiments, error injections such as, for example, Poison Memory Error, Patrol Scrub Error and Explicit Write Back are possible. These error injections allow the OS and/or VMM to perform error recovery verifications that are important for end-to-end recovery capabilities.

According to some embodiments, recoverable error injection is possible. Providing error injection capabilities to the Original Equipment Manufacturer (OEM) and/or the Operating System Vendor (OSV) allows them to validate their platform, OS and application stack before releasing their product. It therefore improves the quality of the products and provides a better RAS experience.

Enterprise class computing systems demand a high level of Reliability, Availability and Serviceability (RAS) features. This is particularly true as core count and memory capabilities continue to increase. Memory reliability is a key RAS issue. While a simplistic view would be that failing memory could be off-lined and replaced with good memory, this is not a viable or complete solution because both platform firmware (such as BIOS reserved memory), boot I/O devices, and OS and/or VMM kernels and drivers have a tendency to utilize non-paged pools of memory that are essentially pinned to a specific system address space. As a result, a hot replace of these memory regions is not possible.

According to some embodiments, failing memory is migrated over in a software, firmware, OS, and/or VMM transparent manner such that the address space occupied by the failing memory is transparently remapped to a different set of memory devices. In some embodiments, memory migration is a RAS feature that enables the user to migrate memory from one memory component to another, thus enabling the serviceability of the memory in case of failures. According to some embodiments, memory is migrated from one memory component to another.

Some enterprise class server processors (for example, Intel Xeon processors) implement Write On Write (WOW) copy engine. The functionality of the WOW copy engine is that when data is written to a source memory controller it also copies the data to the target (slave) memory controller.

Some enterprise class server processors may implement Write On Read (WOR) copy engine. The functionality of the WOR copy engine is that when data is read from a source memory controller it causes the same data to be written to the target (slave) memory controller.

According to some embodiments, in a QPI link based system with two memory controllers attached to each socket, a memory may be migrated from one CPU to another CPU (from a source memory location coupled to a first CPU to a target memory location coupled to a second CPU).

According to some embodiments, in order to migrate memory from one memory controller to another, all cache lines from the source memory controller are read and written back. The copy operation is performed by System Management Mode (SMM) code to make memory operation transparent to the OS.

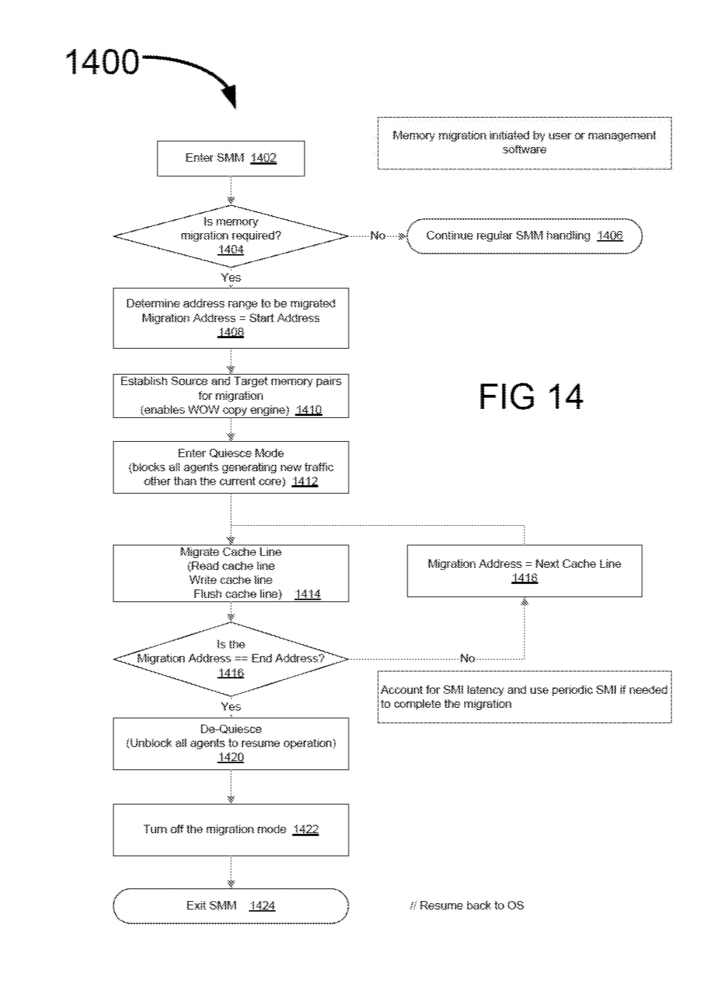

FIG. 14 illustrates a flow 1400 according to some embodiments. In some embodiments, flow 1400 represents a memory migration flow. Flow 1400 starts at 1402 where it enters System Management Mode (SMM), for example, in response to a memory migration initiated by a user or by management software. At 1404 a decision is made as to whether or not memory migration is required. If memory migration is not required at 1404, then regular SMM handling is continued at 1406. If memory migration is required at 1404, then the address range to be migrated is determined at 1408. Source and target memory pairs for migration are established at 1410 (for example, this enables the WOW copy engine). Quiesce Mode is entered at 1412. This blocks all agents other than the current core from generating new traffic. The cache line is migrated at 1414 (for example, “read cache line, write cache line, flush cache line). A determination is made at 1416 as to whether the migration address is the end address. In some embodiments, SMI latency is accounted for and a periodic SMI is used if necessary to complete the migration. If the migration address is not the end address at 1416 then the migration address is incremented to the next cache line at 1418. The cache migration at 1414, the determination at 1416 and the migration address incrementing at 1418 are repeated until the migration address is equal to the end address at 1416. A De-Quiesce is implemented at 1420 to unblock all agents and resume operation. The migration mode is turned off at 1422. An exit from SMM is performed at 1424 and flow resumes back to the OS.

According to some embodiments, once memory migration is initiated by a user or management software, one or more (or all) of the following operations are implemented:

1. Enter SMM mode

2. Determine the address region that needs to be migrated

3. Establish the source and target memory controller combinations for migration and/or mirroring (this enables the WOW copy machine, for example)

4. Enter Quiesce Mode—This blocks any new transaction generated by any other cores, memory controllers or I/O devices reaching the QPI fabric (including DMA from I/O devices)

5. Migrate Cache Line—This is implemented, for example, by reading a cache line from a source, writing the cache line back at the same address (since the WOW copy engine is enabled, the data is copied to both source and target), and flushing the cache line. If there are errors in the source cache line, additional steps may be introduced to handle the errors

6. Repeat step 5 until all the determined address ranges are migrated—If the copy operation cannot be performed in a single SMI latency duration schedule a periodic SMI to copy the remaining memory ranges

7. De-Quiesce the System (exit quiesce mode)—this unblocks the cores, memory, and I/O devices to continue normal operation

8. Once the copies of all the regions are completed, migration mode can be turned off and the target can be made as a source. This allows the original source memory controller to be removed for service

9. Exit SMM

10. Back to the OS code

In some systems (such as FSB systems), memory protection is limited to a DIMM pair. With the large memory capacities of QPI based systems of today and in the future the ability to migrate memory at a larger granularity is required. Unlike Memory Controller Hub (MCH) based configurations, QPI based systems have the ability to scale the system (and hence it's memory). Thus, generic hardware that can handle arbitrary connectivity on a QPI system would be prohibitively expensive. According to some embodiments, hardware cost is optimized by allowing the software to perform a memory copy operation with minimum hardware. A hardware based solution is costly. However, in some embodiments a solution using software and a minimal amount of hardware is implemented in a cost effective manner.

Migration may be implemented using memory reading and writing operations. However, if a DMA is in progress while writing data the DMA data might be overwritten. According to some embodiments, Quiesce Mode is used in order to help migrate memory.

According to some embodiments, Write On Write (WOW) copy engine is enabled, Quiesce Mode is entered in order to block transactions from all other cores, memory, I/O including DMA, etc., memory read and write operations are performed to copy data from the source memory to the target memory, the cache line is flushed to make sure the data reached the target, and Quiesce Mode is then exited to unblock the transactions from all other cores, memory, and I/O. In some embodiments Read On Write (ROW) copy engine is implemented rather than a Write On Write (WOW) copy engine.

In some embodiments, Write On Read (WOR) copy engine is implemented. Some enterprise class server processors may implement Write On Read (WOR) copy engine. The functionality of the WOR copy engine is that when data is read from a source memory controller it causes the same data to be written to the target (slave) memory controller.

Some embodiments have been described herein as being applicable to System Management Interrupt (SMI) technology. However, other implementations relate to other runtime interfaces. For example, in some embodiments, a Platform Management Interrupt (PMI) is used.

Some embodiments have been described herein and illustrated as a socket that includes a processor core and/or integrated memory, for example. However, in some embodiments further components are integrated into the socket. For example, in some embodiments, an I/O root complex is integrated in the processor socket, for example. In some embodiments, I/O devices are integrated in the processor socket. Further embodiments of additional components integrated into the processor socket are also apparent in current and future implementations of the embodiments.

Although some embodiments have been described herein as being applicable to QPI based systems, according to some embodiments these particular implementations may not be required. That is, embodiments described herein are applicable in some embodiments to any coherent link and are not limited to QPI. In some embodiments, non-QPI based systems are implemented. In some embodiments, node controller based systems are implemented.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an, embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
receiving a request to perform an error injection or a memory migration;
entering a mode that blocks requests from agents other than a current processor core or thread;
injecting the error or migrating the memory; and
exiting the mode that blocks requests from the agents other than the current processor core or thread.

2. The method of claim 1, wherein the receiving, entering, injecting or migrating, and exiting are performed in a system management mode.

3. The method of claim 1, wherein the mode that blocks requests from agents other than the current processor core or thread in a quiesce mode.

4. The method of claim 3, wherein the quiesce mode is entered by writing to a processor specific register.

5. The method of claim 1, wherein the entering brings a system to a known state before injecting the error or migrating the memory.

6. The method of claim 1, wherein injecting the error includes:
flushing a cache line in which the error will be injected;
reading an error injection address;
disabling speculative loads and/or prefetch;
writing an error injection address and an injection type to the current processor;
polling for error injection in a register; and
enabling the cache.

7. The method of claim 1, wherein the injection type is one or more of a poison memory error, a patrol scrub error, and/or an explicit write back error.

8. The method of claim 1, further comprising enabling a write on write copy engine, a read on write copy engine, or a write on read copy engine.

9. The method of claim 1, further comprising enabling a write on write copy engine, wherein the write on write copy engine copies data to a target memory controller when a cache line is written to a source memory controller.

10. The method of claim 1, wherein the memory migration includes performing memory read and write operations to copy data from a source memory to a target memory.

11. The method of claim 10, wherein the memory migration includes flushing a cache line to make sure the data reached the target.

12. The method of claim 1, wherein the agents other than the current processor core or thread include one or more other processor cores or threads, memory controllers, input/output devices and/or direct memory accesses.

13. The method of claim 1, wherein the error injection allows an operating system and/or a virtual machine monitor to perform error recovery verifications.

14. A system comprising:
a system management module adapted to receive a request to perform an error injection or a memory migration, enter a mode that blocks requests from agents other than a current processor core or thread, inject the error or migrate the memory, and exit the mode that blocks requests from the agents other than the current processor core or thread.

15. The system of claim 14, wherein the mode that blocks requests from agents other than the current processor core or thread is a quiesce mode.

16. The system of claim 15, wherein the quiesce mode is entered by writing to a processor specific register.

17. The system of claim 14, wherein the system management module is adapted to bring a system to a known state before injecting the error or migrating the memory.

18. The system of claim 14, wherein the system management module is adapted to inject the error by flushing a cache line in which the error will be injected, reading an error injection address, disabling speculative loads and prefetch, writing an error injection address to the current processor, polling for error injection in a register, and enabling the cache, speculative load and prefetch.

19. The system of claim 14, wherein the error includes a poison memory error, a patrol scrub error, and/or an explicit write back error.

20. The system of claim 14, further comprising a write on write copy engine, a read on write copy engine, or a write on read copy engine.

21. The system of claim 14, further comprising a write on write copy engine, wherein the write on write copy engine is adapted to copy data to a target memory controller when a cache line is written to a source memory controller.

22. The system of claim 14, wherein the system management module is adapted to perform the memory migration by performing memory read and write operations to copy data from a source memory to a target memory.

23. The system of claim 22, wherein the system management module is adapted to flush a cache line to make sure the data reached the target.

24. The system of claim 14, wherein the agents other than the current processor core or thread include one or more other processor cores or threads, memory controllers, input/output devices and/or direct memory accesses.

25. The system of claim 14, wherein the system management module is adapted to perform the error injection by allowing an operating system and/or a virtual machine monitor to perform error recovery verifications.
